(19) United States
(12) Patent Application Publication
(10) Pub. No.: US 2004/0052084 A1
(43) Pub. Date: Mar. 18, 2004

(54) Car rearview mirror assembly

(76) Inventor: Rocky Lin, Taipei (TW)

Correspondence Address: ROCKY LIN, P.O. BOX 26-757, TAIPEI, 106, TW

(21) Appl. No.: 10/330,950

(22) Filed: Dec. 24, 2002

(30) Foreign Application Priority Data
Sep. 16, 2002 (TW) 91214545

(51) Int. Cl. B60R 1/12

(52) U.S. Cl. 362/494; 362/84; 362/135

(57) ABSTRACT

A rearview mirror assembly for a car includes a casing, a mirror and a light-emitting element. The casing has an opening at one end thereof. The mirror engages with edges of the opening. The light-emitting element has a light-emitting body formed along a periphery of the mirror, and a transparent strip encapsulating the light-emitting body and the periphery of the mirror body. By means of the light-emitting element of the rearview mirror assembly, a car driver is aided in evaluating the distance between the car and other neighboring cars by observing the mirror to effectively prevent traffic accidents and increase driving safety.

### BACKGROUND OF THE INVENTION

1. Field of the Invention

The invention relates to a rearview mirror assembly for a car. More specifically, the invention relates to a rearview mirror assembly with a light-emitting element that aids a car driver to keep a safe distance from other cars, which prevents traffic accidents.

2. Description of the Related Art

FIG. 1 is an exploded view of a conventional rearview mirror assembly. The rearview mirror assembly 1a has a casing 10a provided with an opening 11a. The opening 11a receives a mirror 12a thereon. An adjustment portion 13a is arranged inside the casing 10a for adjusting the mirror 12a. A connection element 14a corresponding to the adjustment portion 13a is attached to a rear surface of the mirror 12a. The connection element 14a has a plurality of hooks 15a along a periphery thereof to respectively engage with a plurality of protrusions 16a, so that the connection element 14a is connected to the adjustment portion 13a inside the casing 10a.

In the above conventional rearview mirror assembly, a slot is formed on a side surface of the casing 10a for mounting a transparent lighting case 17a. A lighting device and its circuit are mounted in the casing 10a to indicate in which direction the car is heading. However, it is not easy for the car driver to see other cars behind his/her car, especially in dark conditions. Therefore, traffic accidents may occur.

### SUMMARY OF THE INVENTION

It is therefore a principal object of the invention to provide a rearview mirror assembly with a light-emitting element that aids a car driver in keeping a safe distance from other cars, which prevents traffic accidents.

To accomplish the above and other objectives, a rearview mirror assembly for a car comprises a casing, a mirror, and a light-emitting element. The casing has an opening at one end thereof. The mirror engages with edges of the opening. The light-emitting element comprises a light-remitting body formed along a periphery of the mirror, and a transparent strip encapsulating the light-emitting body and the periphery of the mirror. By means of the light-emitting element of the rearview mirror assembly, a car driver is aided in evaluating the distance between his/her car and other cars by looking at the mirror. Traffic accidents are thereby prevented, and driving safety is improved.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is an exploded view of a conventional rearview mirror assembly;

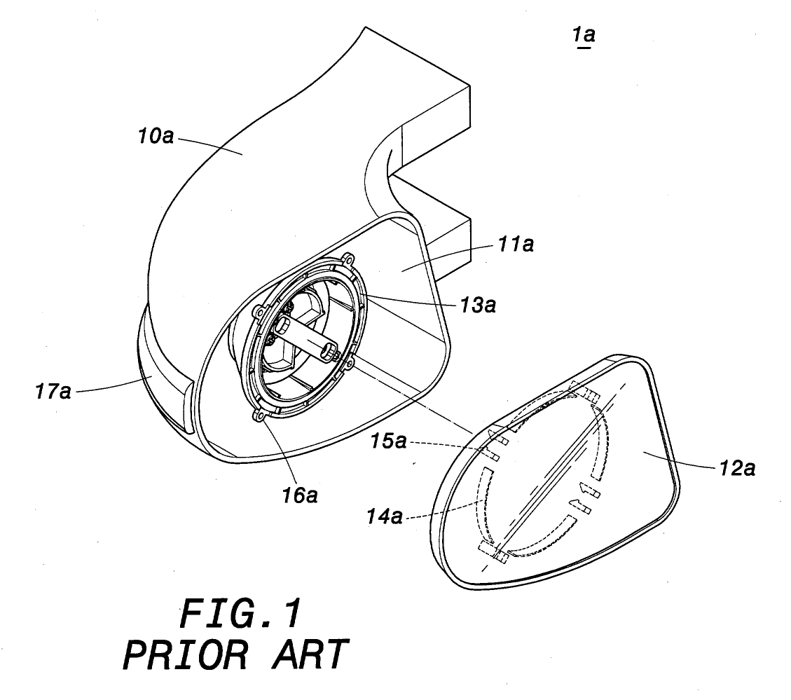

FIG. 2 is an exploded view of a rearview mirror assembly according to one embodiment of the invention;

FIG. 3 is a partially exploded view of a rearview mirror assembly according to one embodiment of the invention;

FIG. 4 is a perspective view of a rearview mirror assembly according to one embodiment of the invention;

FIG. 5 is a cross-sectional view of a light-emitting element of a rearview mirror assembly according to one embodiment of the invention; and

FIG. 6 is a schematic rear view of a car that is provided with a rearview mirror assembly according to an embodiment of the invention.

### DETAILED DESCRIPTION OF THE EMBODIMENTS

Wherever possible in the following description, like reference numerals will refer to like elements and parts unless otherwise illustrated.

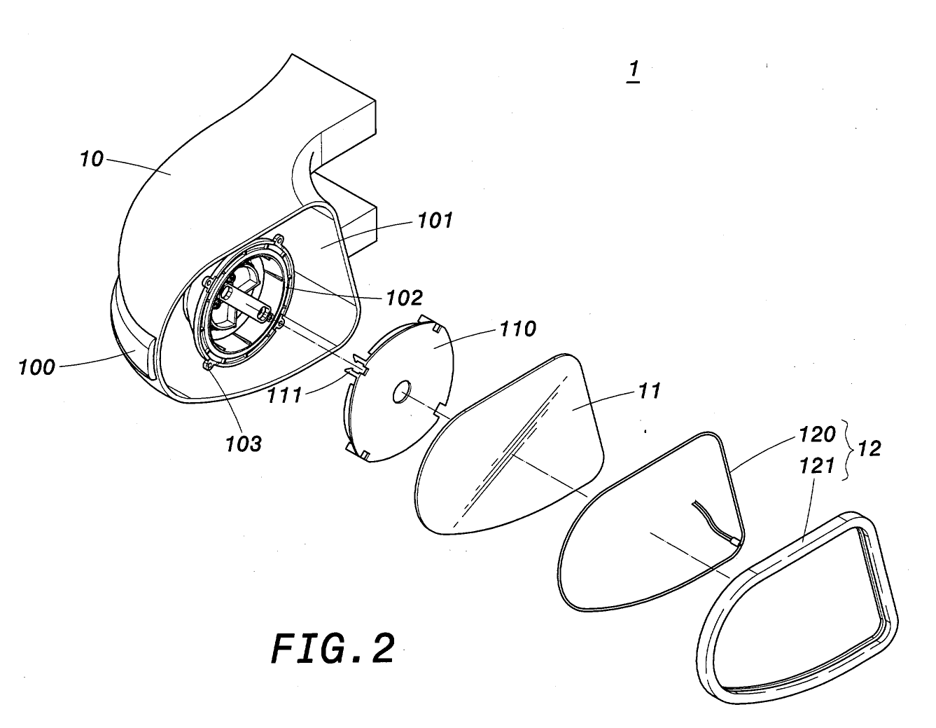

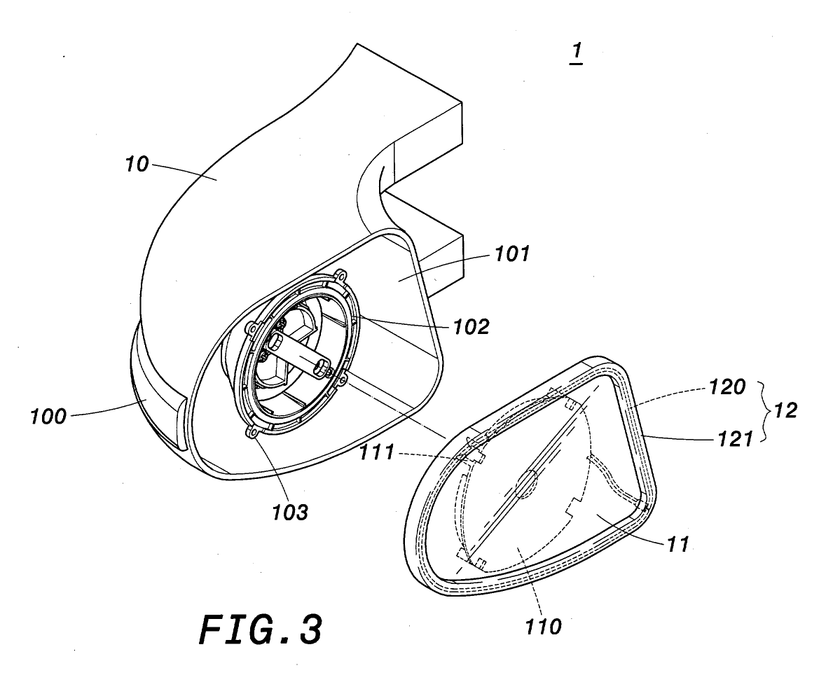

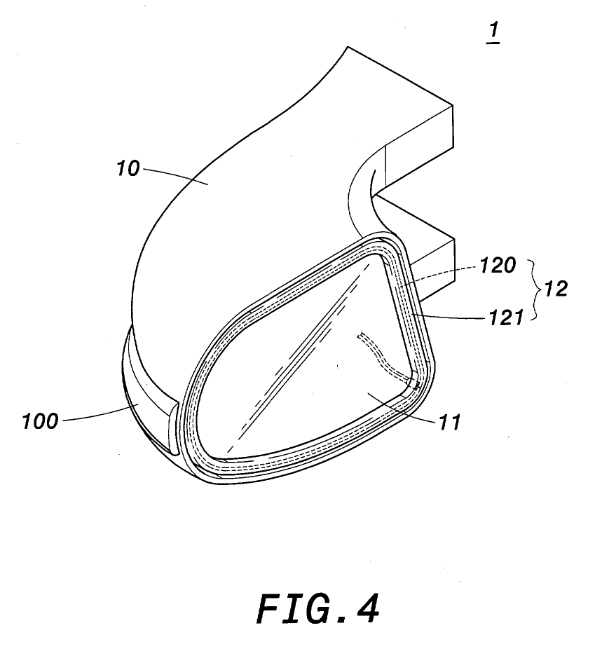

FIG. 2 is an exploded view of a rearview mirror assembly according to one embodiment of the invention. FIG. 3 is a partially exploded view of a rearview mirror assembly according to one embodiment of the invention. FIG. 4 is a perspective view of a rearview mirror assembly according to one embodiment of the invention. The rearview mirror assembly 1 includes a casing 10, a mirror 11 and a light-emitting element 12.

The casing 10 includes an accommodating space therein for accommodating a light-emitting element and a circuit therefor (not shown). The light-emitting element and its circuit indicate in which direction the car is heading. A slot is formed on an external surface of the casing 10 for engaging a transparent case 100. The casing 10 has an opening 101 at one end thereof.

The mirror 11 for reflecting situations behind or beside the car is engaged with edges of the opening 101. A circular connection element 110 having a first surface and a second surface opposite to the first surface is provided. The first surface of the circular connection element 110 is attached to a rear surface of the mirror 11. A plurality of hooks 111 is formed along a periphery of the second surface of the circular connection element 110. An adjustment portion 102 is arranged in the accommodating space inside the casing 10. A plurality of protrusions 103, respectively corresponding to the hooks 111, are formed along a periphery of the adjustment portion 102 so that the hooks 111 respectively engage with the protrusions 103. Thereby, the mirror 11 can be adjusted by operation of the adjustment portion 102.

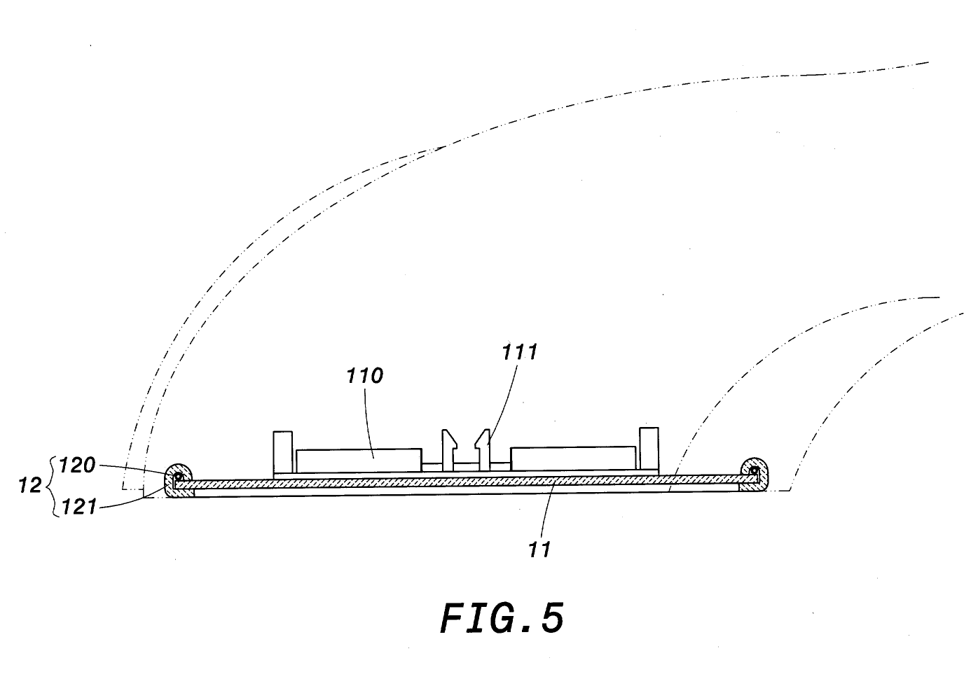

The light-emitting element 12 includes a light-emitting body 120 formed along a periphery of the mirror 11, and a transparent strip 121 encapsulating the light-emitting body 120 and the periphery of the mirror 11, as shown in FIG. 5. The light-emitting body 120 is, for example, a luminescent tube or a neon light. The circuit for the light-emitting body 120 is electrically connected to an electric system of the car. The rearview mirror of the invention is thereby accomplished.

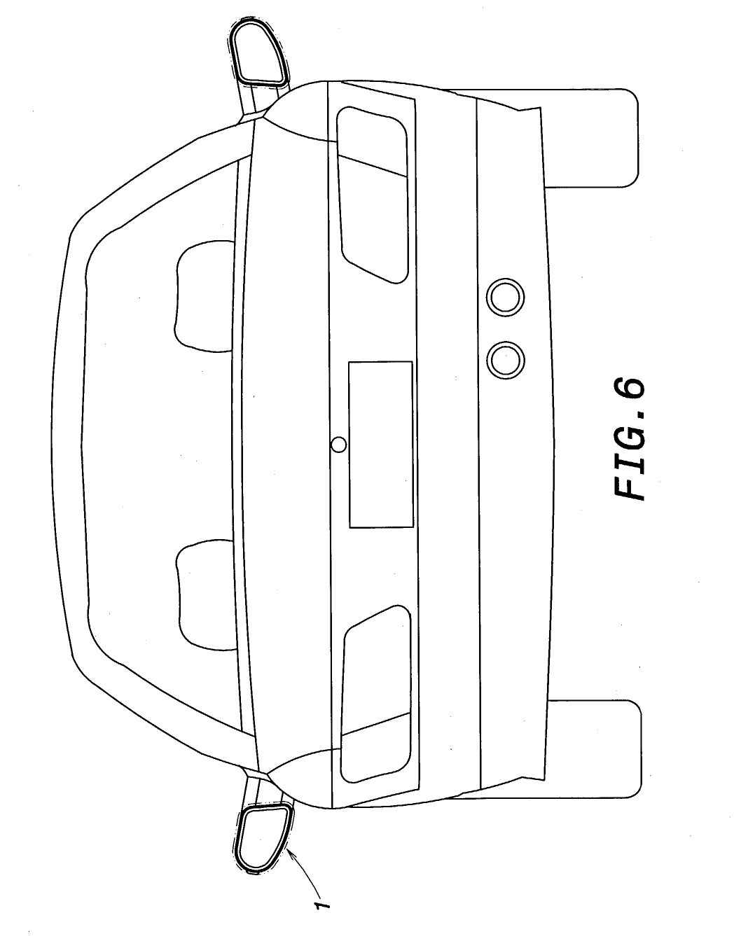

FIG. 6 is a schematic rear view of a car that is provided with a rearview mirror assembly according to an embodiment of the invention. By means of the light-emitting element 12 of the rearview mirror assembly 1, the driver is aided in evaluating the distance between his/her car and the neighbor cars by looking at the mirror 1, especially in dark conditions. Therefore, traffic accidents are prevented and driving safety can be improved.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A rearview mirror assembly for a car, comprising
a casing, having an opening at one end thereof;
a mirror, engaged with edges of the opening of the casing; and
a light-emitting element, respectively comprising a light-emitting body formed along a periphery of the mirror, and a transparent strip encapsulating the light-emitting body and the periphery of the mirror;
wherein by means of the light-emitting element of the rearview mirror assembly, a car driver is aided in evaluating a distance between the car and other neighboring cars by looking at the mirror, which thereby effectively prevents traffic accidents and improves driving safety.

2. The rearview mirror assembly of claim 1, wherein the casing respectively includes an accommodating space therein, a slot formed on an external surface of the casing for engaging a transparent case, and a light-emitting body located inside the accommodating space.

3. The rearview mirror assembly of claim 1, wherein a circular connection element having a first surface and a second surface opposite to the first surface is further provided, the first surface of the circular connection element being attached to a back surface of the mirror body, a plurality of hooks being formed along a periphery of the second surface of the circular connection element, an adjustment portion being arranged in the accommodating space of the casing, and a plurality of protrusions respectively corresponding to the hooks being formed along a periphery of the adjustment portion, so that the hooks respectively engage with the protrusions.

4. The rearview mirror assembly of claim 1, wherein the light-emitting body is a luminescent tube.

5. The rearview mirror assembly of claim 1, wherein the light-emitting body is a neon light.
